(19) United States
(12) Patent Application Publication
(10) Pub. No.: US 2010/0193660 A1
(43) Pub. Date: Aug. 5, 2010

(54) Apparatus for locking objects to a frozen body of water

(76) Inventors: Jeffrey Michael Colla, (US); Benjamin Michael Colla, Minneapolis, MN (US)

Correspondence Address: Jeffrey Michael Colla, 3833 France Ave South, Minneapolis MN, MN, 55416, US

(21) Appl. No.: 12/689,111

(22) Filed: Jan. 18, 2010

Related U.S. Application Data
(60) Provisional application No. 61/205,456, filed on Jan. 20, 2009.

(51) Int. Cl. F16M 13/02; F16M 13/00

(52) U.S. Cl. 248/552

(57) ABSTRACT

An apparatus to lock objects to a frozen body of water (ice) having a bracket and the ability to attach it to the ice in a variety of ways and a lid to protect the bracket from access. The bracket and lid in combination have the ability to secure objects of value in a variety of ways preventing movement. In the preferred embodiment, the bracket sits atop a partially drilled ice hole and is secured to the ice via multiple devices. The bracket has a rotating vertical eyebolt that fits through an aperture in the lid providing the structure to lock the apparatus via a padlock and cable to valuable objects preventing their movement.

### CROSS REFERENCE TO RELATED APPLICATIONS

This application is based on provisional application Ser. No. 61/205,456, filed on Jan. 20, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of ice fishing and more specifically to an apparatus for locking valuable objects to a frozen body of water.

### BACKGROUND

1. Description of Prior Art History

Historically ice fishing has been increasing in popularity due the improvements in fish management and in the comforts for fishing in the winter. Specifically, portable ice fishing shelters have made great strides in lightness and ease of setup allowing greater mobility. Heaters have become small, efficient, lightweight and with oxygen safety mechanisms adding to fishing enjoyment and comfort. Minnesota alone licensed over 156,000 ice fishing houses in 2007. There are estimated to be over 3,660,000 ice anglers in the U.S. as well. (Source In-Fisherman 12/07) The vast majority of shelters being bought are now portable, allowing easy movement to find and catch fish without sacrificing comfort.

2. Prior

In the past, most ice fish shelters were permanent, hard side houses. They were comfortable but not easily moved. With the advent of portable fishing shelters, fisherman now have the mobility, to follow fish and still have the comfort from the cold and wind. But with portability, came susceptibility to wind movement. The canvas shelters, many with slippery bottoms, were very lightweight and became windy sails on the frozen lakes. In an effort to prevent wind movement, products like HT Enterprise's shelter anchors and Eskimo's ice anchors were developed to secure shelters to the ice. Additional products like the Ultimate Ice Anchor also prevented wind movement. U.S. Pat. No. 3,305,984 (1963) by Michael Borcuk offered a means to secure items via a rope and hook. All these products while assisting with preventing wind movement, offered no means to lock objects and prevent theft. All these devices are quite accessible and easily removed from the ice by design. They were simple means to prevent portable ice fishing shelters from being blown away in the wind. Fisherman today, want to leave their portable fishing shelters and valuables on a “hot” fishing spot, to run into town or hold position overnight. Today's GPS and detailed lake maps allow key fishing spots to be identified. Having to setup and take down a fishing shelter every time primarily because of theft fears, is a distinct disadvantage and inconvenience.

### Deficiency

With the popularity of portable ice shelters, there has been no safe and easy way to prevent theft of the shelter itself as well as its contents. In simple terms, these shelters cost hundreds of dollars and without a secure way to prevent theft, everything valuable is removed from the ice when not fishing. Every portable fisherman carts ice augers, fishing poles and the shelter itself off the lake when done fishing. The inconvenience and hassle factor are high with this approach. In particular, it decreases quality fishing time due to repeated set-up and take-down procedures. If a good fishing spot is found, one must set up in the exact location the next day. If there was an easy, simple way to secure the shelter and contents this all could be precluded. Now there is a easy means of securing portable ice fishing houses and other valuables to the lake preventing theft or movement by the wind. This is commercially available by this inventor today, in an apparatus called ICE-LOK. This allows fisherman to leave their portable fish houses on the lake overnight, adding greatly to the “fishing experience”. Not only portable fishing shelters, but generators, propane tanks, gas ice augers and other valuables can be protected as well. Fisherman no longer need, to worry about theft or wind movement. The device is lightweight, corrosion proof and yet very strong. It can be set-up and taken down very quickly and is freeze-proof. The apparatus is very flexible, offering multiple ways to attach itself to the ice as well as to objects of value.

### OBJECTS AND ADVANTAGES

The primary object of the invention is to provide multiple means of locking valuable objects to a frozen body of water preventing theft and/or movement by the wind. Another object of the invention is to provide a lockable lightweight device that can allow fisherman to leave their portable fish houses on the lake overnight increasing the “fishing experience”.

Another object of the invention is to provide a lockable means of keeping items like gas ice augers, generators, propane tanks and other valuable items secured to the ice itself.

Another object of the invention is to provide a simple and fairly quick means to secure items from the wind and theft with an apparatus that is lightweight, freeze-proof and yet portable.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a exploded view of the preferred embodiment assembly detail.

FIG. 2 is a perspective view of the preferred embodiment assembled.

FIG. 3 is a perspective view of the preferred embodiment assembly deployed.

FIG. 4 is a perspective view of an alternate embodiment of a universal half bracket.

FIG. 5 is a perspective view of an alternate embodiment of a hinged surface mount version.

FIG. 6 is a perspective view of an alternate shelter attachment.

FIG. 7 is a perspective view of an alternate clip attachment.

### REFERENCE NUMERALS IN THE DRAWINGS

10 Lid
11 Eyebolt
12,13,14,15 Nut
16,17 Washer
18 Bracket
20,21 Ice Anchors
22,23 Ice Screws
24 Padlock
25 Securing Cable
30 Upper hinge leaf
31 Lower hinge leaf
32,33,34 Ice Screws
40 Portable fishing shelter
41 Hasp
50 Support bar of a portable fishing shelter
51 Retaining clip

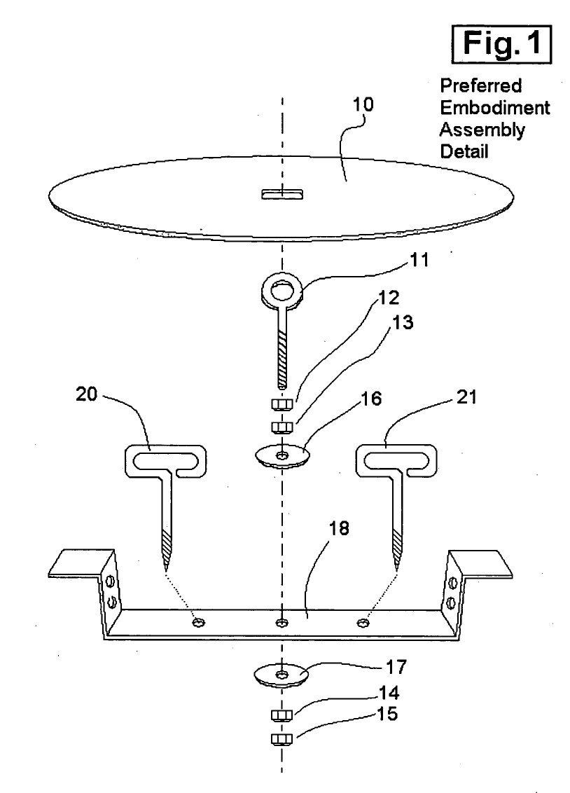

### DETAILED DESCRIPTION OF THE PREFERRED EMBODIMENTS AND FIGS. 1 TO 7

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

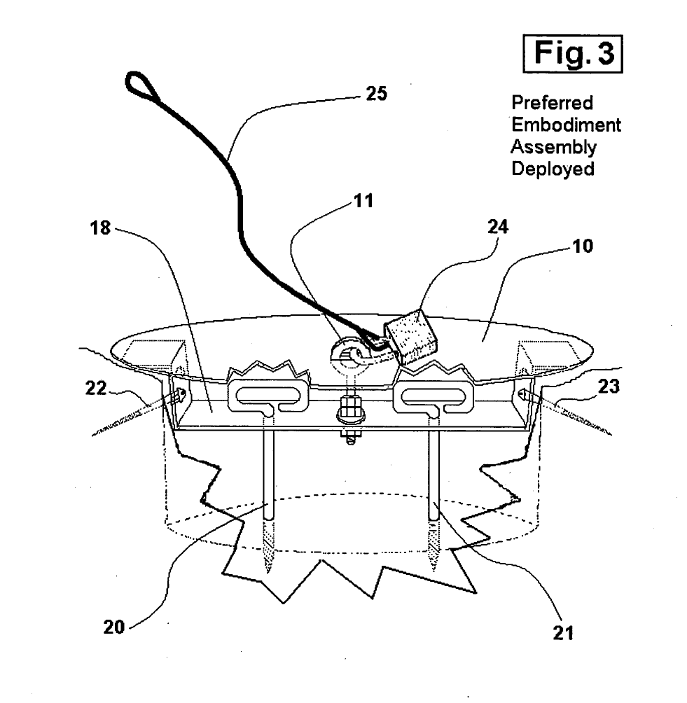

Turning now to the drawings, FIG. 1 is the complete assembly detail of the preferred embodiment of the apparatus for locking objects to a frozen body of water (ice), thus preventing unwanted movement of valuable objects. The apparatus comprises a bracket 18 and lid 10 and the means to attach to the ice and objects of value. A bracket 18 sits atop a partially drilled ice hole by means of flanges that are on each side. These flanges support bracket 18 on a partially drilled ice hole. A partially drilled hole is one that is not completely drilled through to the water. Multiple apertures in said bracket 18, provide the means to secure itself to the ice. Ice anchors 20 and 21 can be inserted in the two apertures on either side of eyebolt 11. This is the preferred ice attach method by either manually screwing ice anchors 20 and 21 into the ice or by hanging them in the partially drilled ice hole and adding water. The water should cover the threads of the ice anchor and given some time and cold temperatures, will freeze itself to the ice. In either case, the ice anchors will be attached to the ice and can be easily removed from the ice by unscrewing each ice anchor counter-clockwise by hand. Eyebolt 11 attaches to the center hole in bracket 18 by nuts 12 and 13 and washer 16 from the top and washer 17 and nuts 14 and 15 from below. Nuts 12, 13, 14 and 15 and washers 16 and 17 serve to secure the eyebolt 11 to bracket 18 but still allow 360 degree rotation. This is an important feature that can help thwart thieves and provide means for rotational attachment. Eyebolt 11 protrudes upward through the rectangular shaped aperture in lid 10, providing the means to padlock the apparatus. Lid 10 sits atop of bracket 18 and prevents the apertures in bracket 18 from being accessed. With lid 10 in place, and locked to eyebolt 11, ice anchors 20 and 21 cannot be accessed and removed from the ice. The combination of bracket 18, eyebolt 11 and lid 10, comprises the ability of the apparatus to be locked and unlocked from above the ice. Two side holes on each side of bracket 18 allow for optional ice screw attachment means shown more clearly in FIG. 3 items 22 and 23. These ice screws 22 and 23 and ice anchors 20 and 21 provide a multiple means of attaching bracket 18 to the ice.

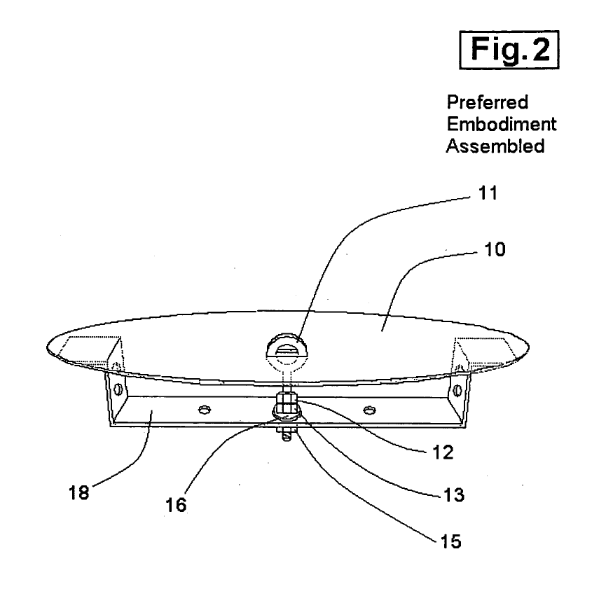

Turning to FIG. 2, this shows the preferred embodiment of the apparatus assembled. This view shows the apparatus assembled as it would atop a partially drilled ice hole. Lid 10 is positioned on top of eyebolt 11 and provides exposure for a lockable means. Bracket 18 is secured to eyebolt 11 via nuts 12 and 13 and washer 16 from the top. From below, bracket 18 is secured to eyebolt 11 by washer 17 and nuts 14 and 15. Note, washer 17 and nut 14 are hidden from view by bracket 18 in this figure. The apparatus has all stainless steel nuts 12, 13, 14 and 15, washers 16 and 17 and eyebolt 11 in the preferred embodiment and an all aluminum lid 10 and bracket 18. These are lightweight, strong and corrosion resistant materials providing excellent durability.

Turning to FIG. 3, this shows the preferred embodiment assembly deployed in the locked position in a partially drilled ice hole. Bracket 18 sits atop a partially drilled ice hole and is secured to the ice via ice anchors 20 and 21. Optional ice screws 22 and 23 are shown secured to the ice through side holes in bracket 18. The lid 10 is placed over eyebolt 11 and locked in place with padlock 24. Thus lid 10 cannot be removed from eyebolt 11, thereby making ice anchors and 21 and ice screws 22 and 23 inaccessible from above the ice. A strong cable 25 is also attached by padlock 24 to eyebolt 11. The cable 25 or chain can be attached to valuable objects by looping through an opening in the object or by other means. Once padlock 24 is locked to eyebolt 11 and cable is secured to valuable objects, they cannot be stolen or moved with the wind.

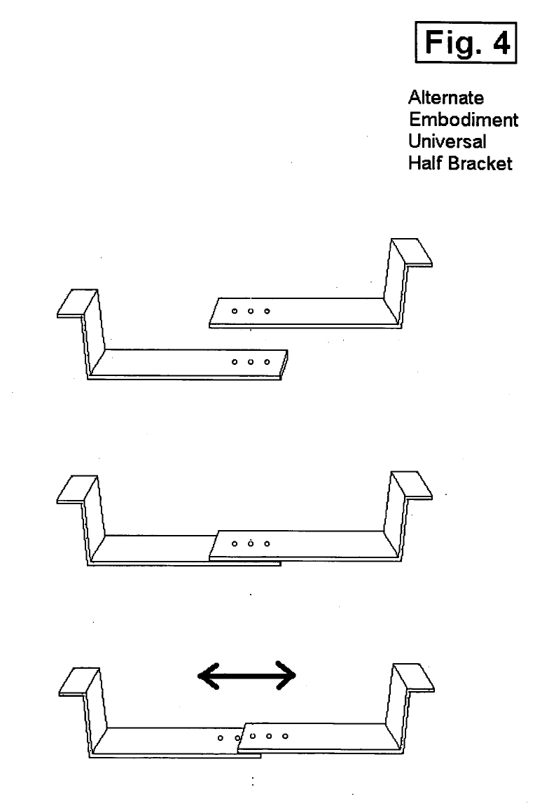

Turning to FIG. 4, this shows the alternate embodiment for a universal half bracket. This provides bracket adjustability to fit a variety of partially drilled diameter ice holes. This is done by moving two half brackets side to side and securing with an eyebolt and extra bolt for the desirable bracket width. The multitude of apertures in the half brackets are spaced such the they can accommodate a range of the most common sized ice fishing holes such as 6, 7, 8, 9 and 10 inches in diameter. An eyebolt should be housed by the centered apertures and an additional bolt in the side apertures will prevent unwanted pivoting of the bracket around the eyebolt. This arrangement will allow one bracket design to fit all different drilled ice holes sizes reducing costs and increasing flexibility.

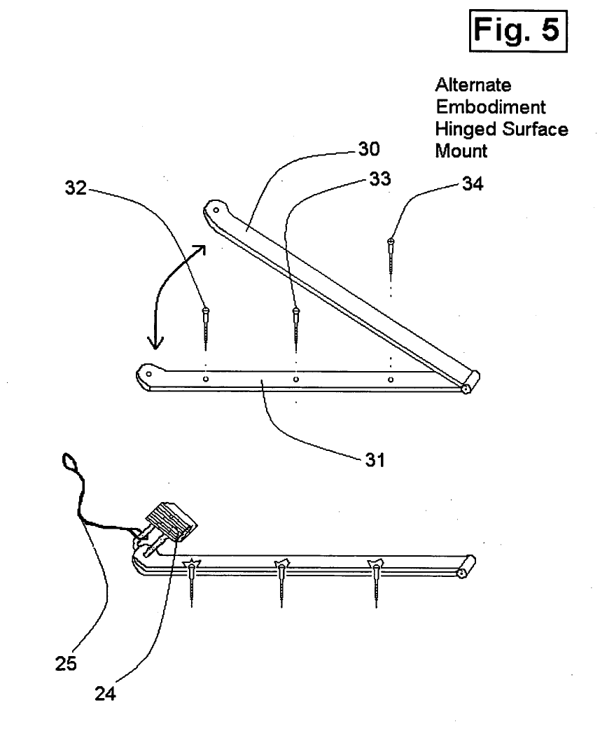

Turning to FIG. 5, this shows the alternate embodiment for a hinged surface mount apparatus. The hinged apparatus consists of upper hinge leaf 30 and lower hinge leaf 31, hinged together at one end. The other end of the hinge leaves, are curved upward with aligning apertures to accommodate a lock 24. The top half of FIG. 5 shows the hinged leaves 30 and 31 open and ready for three ice screws 32, 33 and 34 that are the means to secure the apparatus to the surface of the ice without the need for a partially drilled ice hole. The ice screws 32, 33 and 34 are screwed into the ice with a portable drill. Ice nails could also be used in these apertures. The lower half of FIG. 5 shows the hinged apparatus closed with the ice screws 32, 33 and 34 secured into the ice. As shown, padlock 24 fits through aligning apertures and cable 25 keeps the apparatus locked and secured to valuable objects preventing unwanted movement.

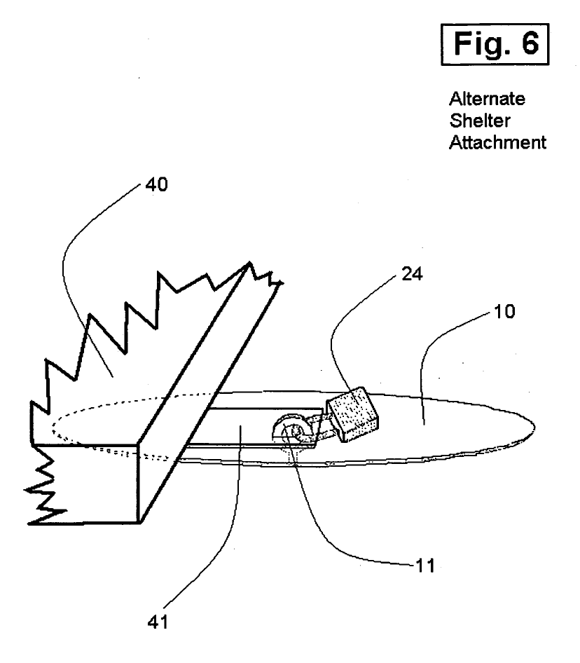

Turning to FIG. 6, this shows an alternate shelter attachment means whereby the portable fishing shelter 40 houses the means for attachment to the apparatus. Hasp 41 is secured to the portable fishing shelter by design and has a rectangular aperture to surround eyebolt 11. Hasp 41 sits over eyebolt 11 and over lid 10 providing an adequate opening to lock padlock 24, thereby locking the portable fishing shelter 40 to the frozen body of water (ice). It is suggested that to prevent having the apparatus and objects spin around the eyebolt 11 in the wind, two hasps 41 need to be secured to the ice with separate apparatuses. Two points of contact with the ice will prevent unwanted spinning.

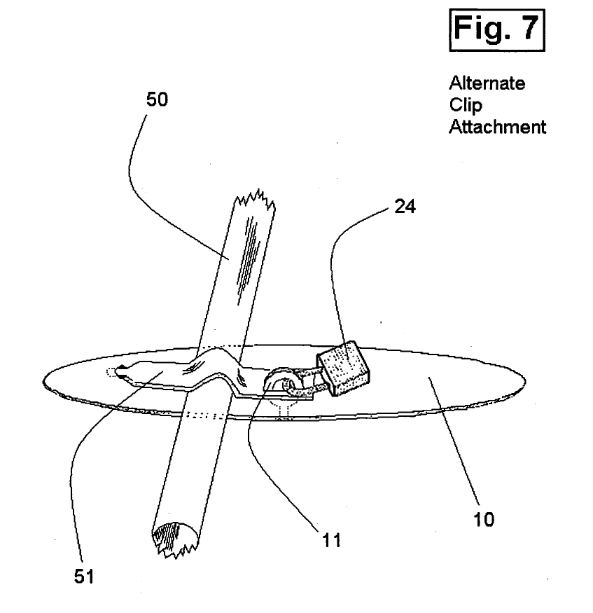

Turning to FIG. 7, this shows an alternate clip attachment means whereby the support bar of a portable fishing shelter 50 is attached to the apparatus preventing unwanted movement in the wind or theft. Retaining clip 51 is shaped to conform to the shape of the support bar 50 of a portable fishing shelter. The support bar 50 supports the fishing shelter horizontally, along the ice and typically has a cross section of a circular tube, but can also be square or rectangular. Retaining clip 51 has a rectangular aperture to surround eyebolt 11. The opposite end of retaining clip 51, can be shaped to fit into an aperture in lid 10 for ease of use. When retaining clip 51 is locked to eyebolt 11 with padlock and the other end is inserted into the aperture, the support bar of the portable fishing shelter 50 is locked to the ice. An alternative means could also be a bolt, washer and nut to secure the non-locking end of retaining clip 51. It is suggested to prevent having the apparatus spin around the eyebolt 11 in the wind, two retaining clips 51 need to be secured to the ice with separate apparatuses. Two points of contact with the ice will prevent unwanted spinning.

From the description above, a number of advantages of my apparatus for locking valuable objects to a frozen body of water become evident;

a. Portable fishing shelters and other valuables can be protected from theft and wind movement, thereby increasing the “fishing experience” for ice fisherman.

b. The apparatus is easily locked and unlocked and provides a multiplicity of means to secure itself to the ice.

c. The apparatus is strong, yet lightweight making it portable and freeze-proof.

d. The apparatus provides for multiple means to attach itself to valuable objects utilizing retaining clips, hasps, cables, chains and other means to lock itself.

What is claimed is:

1. An apparatus for locking objects to a frozen body of water or ice comprising:
a bracket that sits atop the ice providing the means for securing itself to the ice;
a lid that sits on top of said bracket as a means for preventing said bracket from being removed from the ice;
and a means of the said bracket and said lid to be secured together and locked to said objects preventing unwanted movement.

2. The apparatus as claimed in claim 1 further comprising the ability of the said bracket to be secured to the frozen body of water by multiple means including but not limited to; ice anchors by manual means, self tapping screws by portable drill, ice nails by manual means and by freezing ice anchors with water.

3. The apparatus as claimed in claim 1 further comprising the ability to be locked and unlocked from above the ice.

4. The apparatus as claimed in claim 1 further comprising the ability to attach a cable or chain to a lock said objects, preventing said objects from theft and wind movement.

5. The said bracket as claimed in claim 1 comprising two halves with multiple apertures with the means for universal adjustability for different sized ice holes.

6. The apparatus as claimed in claim 1 further comprising the ability to attach to said objects via retaining clips, hasps as a means to lock said objects.

7. The apparatus as claimed in claim 1 comprising lightweight, corrosion resistant and strong materials including but not limited to; stainless steel and aluminum.

8. The apparatus as claimed in claim 1 comprising the ability to lock itself to portable fishing shelters by means designed and built into the shelter itself.

9. The apparatus as claimed in claim 1 comprising the ability to be attached to a frozen body of water through surface means, and/or the side of a partially drilled ice hole, and/or the bottom of a partially drilled ice hole.

10. An apparatus for locking objects to a frozen body of water or ice comprising:
a lower hinge leaf that sits atop the ice providing the means for securing itself to the ice;
a upper hinge leaf that sits atop said lower hinge leaf as a means for preventing said lower hinge leaf from being removed from the ice;
a means of said lower hinge leaf and said upper hinge leaf to be hinged together;
and in combination, the means to be secured together and locked to said objects preventing unwanted movement.

11. The apparatus as claimed in claim 10 further comprising the ability of the said lower hinge leaf to be secured to the frozen body of water by multiple means including but not limited to; self tapping screws by portable drill and ice nails by manual means.

12. The apparatus as claimed in claim 10 further comprising the ability to be locked and unlocked from above the ice.

13. The apparatus as claimed in claim 10 further comprising the ability to attach a cable or chain to a lock said objects, preventing said objects from theft and wind movement.

14. The apparatus as claimed in claim 10 further comprising the ability to attach to said objects via retaining clips, hasps as a means to lock said objects.

15. The apparatus as claimed in claim 10 comprising lightweight, corrosion resistant and strong materials including but not limited to; stainless steel and aluminum.

16. The apparatus as claimed in claim 10 comprising the ability to lock itself to portable fishing shelters by means designed and built into the shelter itself.
